(19) United States
(12) Patent Application Publication
(10) Pub. No.: US 2011/0068926 A1
(43) Pub. Date: Mar. 24, 2011

(54) Hand Ring Having a Biomedical Monitoring Function

(76) Inventors: Gwo-Jia Jong, Kaohsiung (TW); Gwo-Jiun Horng, Kaohsiung (TW)

(21) Appl. No.: 12/577,774

(22) Filed: Oct. 13, 2009

(30) Foreign Application Priority Data
Sep. 18, 2009 (TW) 098131461

(51) Int. Cl. G08B 23/00

(52) U.S. Cl. 340/573.1

(57) ABSTRACT

A hand ring having a biomedical monitoring function includes at least one sensor unit, a control circuit, a data-transmitting circuit and at least one display device. The control circuit electrically connects with the sensor unit, the data-transmitting circuit and the display device. The sensor unit is used to attach to skins of a wearer so as to directly measure wearer's biomedical data. In data-transmitting operation, the control circuit controls the data-transmitting circuit to transmit the data to a biomedical management center. In addition, the control circuit further output the data to the display device so as to display the data thereon.

### BACKGROUND OF THE INVENTION

1. Field of the Invention

The present invention relates to a hand ring having a biomedical monitoring function. More particularly, the present invention relates to the hand ring utilizing at least one sensor continuously collecting human biomedical information on a wearer's hand.

2. Description of the Related Art

U.S. Pat. No. 6,845,063, entitled “Electronic medical emergency voice bracelet system,” discloses an audible medical emergency system for a patient comprising a bracelet. The bracelet is battery operated and is worn on patient. The bracelet contains audible information about the wearer's health, including warnings about allergies to drugs, medical conditions, doctor's name and phone number, health insurance information. Information is loaded by computer onto a chip in the bracelet. When a button is pressed, a paramedic or doctor or anyone rendering assistance can listen to the information to aid in helping the wearer in an emergency. The information repeats by pushing the button again after it has played. The medical information is entered into a computer from information provided by the wearer and the computer loads the chip or disk.

U.S. Pat. No. 6,223,559, entitled “Medical identification charm bracelet,” discloses a medical identification charm bracelet including a housing for housing an electronic circuit. The electronic circuit includes an audible output device and a visual output device that is activatable to draw attention to the I.D. bracelet and the information inscribed on the various bracelet charm attachments to notify medical personnel of various medical conditions of the wearer.

U.S. Pat. No. 5,877,742, entitled “Medical identification bracelet,” discloses a medical identification bracelet which has electronic circuitry to display detailed patient medical information. The medical identification bracelet has an LCD view screen which displays, in a scrolling fashion, data when a button is pushed.

U.S. Pat. No. 4,078,660, entitled “Medical alert bracelet,” discloses a medical alert bracelet for carrying an emergency supply of a patient's medicament.

U.S. patent application publication No. 20070012771, entitled “RFID bracelet and method for manufacturing a RFID bracelet,” discloses a RFID bracelet. The bracelet is composed of a bottom layer having a top surface and a bottom surface, a radio frequency identification microprocessor attached to the top surface of the bottom layer, an antenna operably coupled to the radio frequency identification microprocessor and attached to the top surface of the bottom layer, a core layer positioned above the bottom layer and attached to the bottom layer, the radio frequency identification microprocessor and the antenna, and a top layer positioned above the core layer and attached to the core layer.

Taiwanese Utility Model Patent No. 342052, “Hand ring having a sensor chip,” discloses a hand ring in communication with a signal generator. The hand ring includes a first strap, a second strap and a sensor chip. The first strap is in corresponding connection with the second strap. An end of the first strap has a connection portion to connect with that provided on an end of the second strap. The sensor chip is mounted between the first strap and the second strap. The sensor chip is used to receive signals generated from the signal generator.

Taiwanese Utility Model Patent No. 323656, “Hand ring device for wireless communication,” discloses a hand ring in communication with a signal generator. The hand ring includes a ring body and a RFID tag. The ring body has a compartment in which to receive the RFID tag which can be removed and reused.

As has been discussed above, these patents are absent to disclose a hand ring having at least one sensor continuously monitoring and collecting human biomedical information on a wearer's hand (e.g. user's hand). Hence, there is a need of providing a hand ring having a sensor device continuously measuring or collecting human biomedical information or conditions.

As is described in greater detail below, the present invention intends to provide a hand ring having a biomedical monitoring function. The hand ring includes a sensor unit to measure human biomedical information, and a data-transmitting circuit to output the human biomedical information to a biomedical management center in such a way as to mitigate and overcome the above problem.

### SUMMARY OF THE INVENTION

The primary objective of this invention is to provide a hand ring having a biomedical monitoring function. The hand ring includes a sensor unit to measure human biomedical information, and a data-transmitting circuit to output the human biomedical information. Accordingly, the human biomedical information can be directly measured and continuously monitored.

The hand ring having a biomedical monitoring function in accordance with an aspect of the present invention includes at least one sensor unit, a control circuit, a data-transmitting circuit and at least one display device. The control circuit electrically connects with the sensor unit, the data-transmitting circuit and the display device. The sensor unit is used to attach to skins of a wearer so as to directly measure wearer's biomedical data. In data-transmitting operation, the control circuit controls the data-transmitting circuit to transmit the data to a biomedical management center. In addition, the control circuit further output the data to the display device so as to display the data thereon.

In a separate aspect of the present invention, the sensor unit includes a MOS electrode material formed on an outer-most surface of the sensor unit.

In a further separate aspect of the present invention, the control is selected from a flexible electronic chip.

In a yet further separate aspect of the present invention, the data-transmitting circuit is selected from a RF integrated circuit.

In a yet further separate aspect of the present invention, the display device is selected from a LCD device or an OLED device.

In a yet further separate aspect of the present invention, the hand ring further includes a warning device electrically connected with the control circuit.

In a yet further separate aspect of the present invention, the hand ring includes a main body having a first surface located on an outer side thereof and a second surface an inner side thereof.

In a yet further separate aspect of the present invention, the sensor unit is provided on the second surface of the main body.

In a yet further separate aspect of the present invention, the data-transmitting circuit is provided on the first surface of the main body.

In a yet further separate aspect of the present invention, the display device is provided on the first surface of the main body.

In a yet further separate aspect of the present invention, the warning device is provided on the first surface of the main body.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a hand ring having a biomedical monitoring function in accordance with the preferred embodiment of the present invention.

FIG. 2 is a rear perspective view of the hand ring having the biomedical monitoring function in accordance with the preferred embodiment of the present invention, depicted in FIG. 1.

FIG. 3 is a structurally schematic view of the hand ring having the biomedical monitoring function in accordance with the preferred embodiment of the present invention.

FIG. 4 is a schematic block diagram of the hand ring having the biomedical monitoring function in accordance with a first embodiment of the present invention.

FIG. 5 is a schematic block diagram, similar to FIG. 4, of the hand ring having the biomedical monitoring function in accordance with a second embodiment of the present invention.

### DETAILED DESCRIPTION OF THE INVENTION

It is noted that a hand ring having a biomedical monitoring function in accordance with the preferred embodiment of the present invention can be applicable to a wide variety of different biomedical management systems or biomedical monitoring systems; and may have any shape or contour which is not limitative of the present invention.

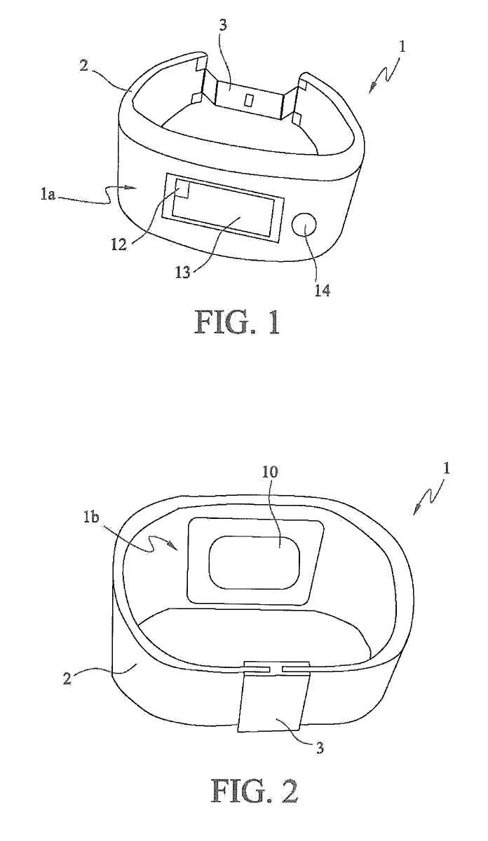

FIG. 1 is a perspective view of a hand ring having a biomedical monitoring function in accordance with the preferred embodiment of the present invention; FIG. 2 is a rear perspective view of the hand ring having the biomedical monitoring function in accordance with the preferred embodiment of the present invention, depicted in FIG. 1. Referring to FIGS. 1 and 2, the hand ring in accordance with the preferred embodiment of the present invention includes a main body 1, a strap 2 and a fastener 3.

Still referring to FIGS. 1 and 2, the main body 1 is formed on the strap 2 and is disposed at a predetermined position of the strap 2 to form a desired shape of the hand ring. The main body 1 is capable of properly contacting with skins of a wearer's hand when wore. The fastener 3 is provided between two ends of the strap 3 such that the fastener 3 can be used to connect and fasten the two ends of the strap 3 when wore. Accordingly, the strap 3 is capable of fixing the hang ring on the wearer's hand.

Referring again to FIGS. 1 and 2, the main body 1 has a first surface 1a located on an outer side of the main body 1, and a second surface 1b located on an inner side of the main body 1. Contained between the first surface 1a and the second surface 1b is the main body 1 of the hand ring in accordance with the preferred embodiment of the present invention.

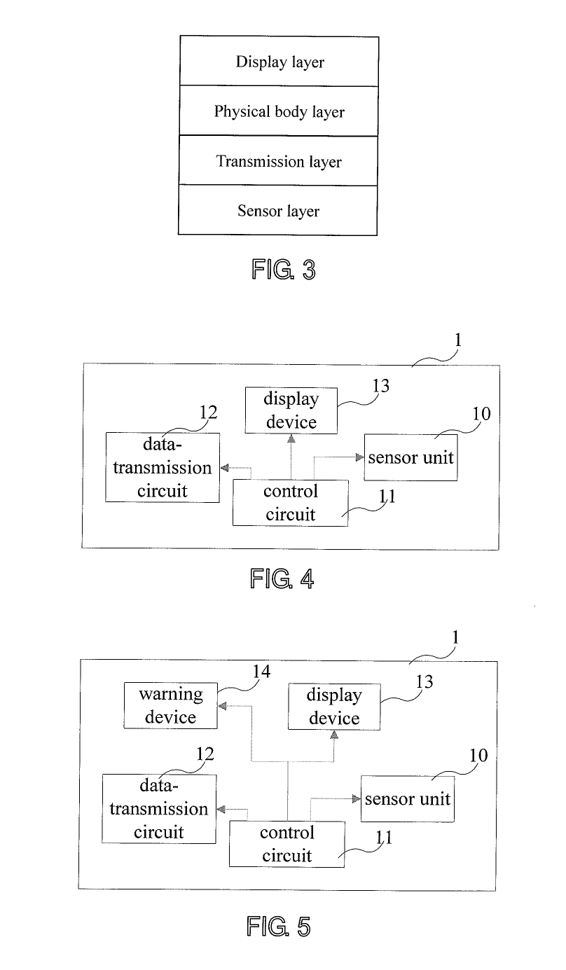

Turning now to FIG. 3, a structurally schematic view of the hand ring having the biomedical monitoring function in accordance with the preferred embodiment of the present invention is shown. Referring to FIG. 3, the hand ring in accordance with the preferred embodiment of the present invention may be formed from four structural layers, including a sensor layer, a physical body layer, a transmission layer and a display layer which are not limitative of the present invention.

Turning now to FIG. 4, a schematic block diagram of the hand ring having the biomedical monitoring function in accordance with a first preferred embodiment of the present invention is shown. Referring to FIGS. 1, 2 and 4, the hand ring in accordance with a first preferred embodiment of the present invention includes a sensor unit 10, a control circuit 11, a data-transmitting circuit 12 and at least one display device 13 which are embedded in the main body 1, as best shown in FIGS. 1 and 2.

Referring to FIGS. 2, 3 and 4, the sensor layer is disposed on the second surface 1b of the main body 1, and is formed with at least one sensor unit 10. The sensor unit 10 is exposed on the second surface 1b of the main body 1, as best shown in FIG. 2, for directly contacting skins of the wearer. The sensor unit 10 is used to measure pulse, body temperature and other biomedical data of the wearer which is not limitative of the present invention. In this preferred embodiment, the sensor unit 10 includes a MOS electrode material formed on an outer-most surface of the sensor unit 10 for directly contacting the wearer's skin.

Referring again to FIGS. 3 and 4, the physical body layer is disposed between the first surface 1a and the second surface 1b of the main body 1, and is formed with a control circuit 11. In this preferred embodiment, the control circuit 11 selected from a flexible electronic chip that allows suitable deformation of the control circuit 11 by pressures.

Referring again to FIGS. 1, 3 and 4, the transmission layer is disposed between the first surface 1a and the second surface 1b of the main body 1, and further includes a data-transmitting circuit 12. In this preferred embodiment, the data-transmitting circuit 12 is selected from a RF integrated circuit (may be abbreviated as “RF IC”) which is not limitative of the present invention. In an alternative, the data-transmitting circuit 12 is disposed on the first surface 1a of the main body 1, as best shown in FIG. 1, for enhancing data transmission.

With continued reference to FIGS. 1, 3 and 4, the display layer is disposed on the first surface 1a of the main body 1, and is formed with at least one display device 13. In this preferred embodiment, the display device 13 is exposed on the first surface 1a of the main body 1, as best shown in FIG. 1, and is used to indicate the pulse, body temperature and other biomedical data of the wearer. In a preferred embodiment, the display device 13 is selected from a LCD device, an OLED device or other equivalent display devices.

Referring again to FIG. 4, the control circuit 11 electrically connects with the sensor unit 10, the data-transmitting circuit 12 and the display device 13. The sensor unit 10 is used to attach to the skin of the wearer so as to directly measure wearer's biomedical data. In data-transmitting operation, the control circuit 11 controls the data-transmitting circuit 12 to transmit the data to a biomedical management center (not shown). In addition, the control circuit 11 further output the data to the display device 13 so as to display the data thereon such that the wearer can observe his biomedical information.

Turning now to FIG. 5, a schematic block diagram of the hand ring having the biomedical monitoring function in accordance with a second preferred embodiment of the present invention is shown. Referring to FIGS. 1, 2 and 4, the hand ring in accordance with a second preferred embodiment of the present invention includes a sensor unit 10, a control circuit 11, a data-transmitting circuit 12, at least one display device 13 and a warning device 14 (i.e. alarm device).

Referring again to FIG. 5, in comparison with the first embodiment, the warning device 14 is further provided in the hand ring of the second embodiment. Reference numerals of the second embodiment of the present invention have applied the identical numerals of the first embodiment, as shown in FIG. 4. The construction of the hand ring in accordance with the second embodiment of the present invention has similar configuration and same function as those of the first embodiment and detailed descriptions may be omitted.

Referring again to FIGS. 1 and 5, the warning device 14 is formed on the first surface 1a of the main body 1, as best shown in FIG. 1, such that a warning signal can be generated to warn a paramedic or doctor or anyone rendering assistance. In operation, the control circuit 11 electrically connects with the warning device 14 so that the control circuit 11 can control the operation of the warning device 14.

With continued reference to FIGS. 1 and 5, the control circuit 11 can operate the warning device 14 to generate a warning signal when the biomedical data are abnormal. In a preferred embodiment, the warning signal may be in the form of warning light, flash, vibration or combination thereof.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A hand ring having a biomedical monitoring function, comprising:
at least one sensor unit used to contact skins of a wearer's hand so as to obtain biomedical data;
a control circuit;
a data-transmitting circuit used to transmit the biomedical data; and
at least one display device displaying the biomedical data;
wherein the control circuit electrically connects with the sensor unit, the data-transmitting circuit and the display device such that the control circuit can convey the biomedical data to the data-transmitting circuit for transmitting to a biomedical management center; the control circuit further conveys the biomedical data to the display device.

2. The hand ring having the biomedical monitoring function as defined in claim 1, wherein the sensor unit includes a MOS electrode material formed on an outer-most surface of the sensor unit.

3. The hand ring having the biomedical monitoring function as defined in claim 1, wherein the control is selected from a flexible electronic chip.

4. The hand ring having the biomedical monitoring function as defined in claim 1, wherein the data-transmitting circuit is selected from a RF integrated circuit.

5. The hand ring having the biomedical monitoring function as defined in claim 1, wherein the display device is selected from a LCD device or an OLED device.

6. The hand ring having the biomedical monitoring function as defined in claim 1, wherein the hand ring further includes a warning device electrically connected with the control circuit.

7. The hand ring having the biomedical monitoring function as defined in claim 1, wherein the hand ring includes a main body having a first surface located on an outer side thereof and a second surface an inner side thereof.

8. The hand ring having the biomedical monitoring function as defined in claim 7, wherein the sensor unit is provided on the second surface of the main body.

9. The hand ring having the biomedical monitoring function as defined in claim 7, wherein the data-transmitting circuit is provided on the first surface of the main body.

10. The hand ring having the biomedical monitoring function as defined in claim 7, wherein the display device is provided on the first surface of the main body.

11. The hand ring having the biomedical monitoring function as defined in claim 7, wherein the warning device is provided on the first surface of the main body.
